(19) United States
(12) Patent Application Publication
(10) Pub. No.: US 2016/0319719 A1
(43) Pub. Date: Nov. 3, 2016

(54) DEVICE AND METHOD FOR RELOADING AN AMMONIA CARTRIDGE FOR REDUCTION OF NITROGEN OXIDES BY SELECTIVE CATALYTIC REDUCTION IN A VEHICLE

(71) Applicant: AAQIUS & AAQIUS SA, Genève (CH)

(72) Inventor: Michael Francis LEVY, Paris (FR)

(73) Assignee: AAQIUS & AAQIUS SA, Geneva (CH)

(21) Appl. No.: 15/105,166

(22) PCT Filed: Dec. 19, 2014
(86) PCT No.: PCT/EP2014/078899

§ 371 Date: Jun. 16, 2016

(30) Foreign Application Priority Data
Dec. 20, 2013 (FR) 1363265

(51) Int. Cl. F01N 3/20; F17C 11/00; B01D 53/94

(52) U.S. Cl. CPC F01N 3/208; B01D 53/9431; F17C 11/00; F01N 2610/02; F01N 2610/1406; F01N 2610/11; B01D 2251/2062; F17C 2221/01; F17C 2227/044; F17C 2265/06; F17C 2270/0168

(57) ABSTRACT

Reloading a cartridge with ammonia for the reduction of nitrogen oxides by selective catalytic reduction, includes memorizing characteristics of the cartridges to be reloaded, including memory zones for a type of cartridge to be reloaded, identifying the type of cartridge in order to recognize the type of cartridge, reloading of the cartridge with a desired amount of ammonia, receiving reloading parameters from the memory zones, a unit for manufacturing ammonia on demand, as a function of a manufacturing instruction, controlling the manufacturing unit in order to transmit to the manufacturing unit a manufacturing setting corresponding to the amount, a supply for carrying out the reloading of the cartridge with the amount, and the supply cooling the cartridge.

### CROSS-REFERENCE TO RELATED APPLICATIONS

This application is a National Phase Entry of International Patent Application No. PCT/EP2014/078899, filed on Dec. 19, 2014, which claims priority to French Patent Application Serial No. 1363265, filed on Dec. 20, 2013, both of which are incorporated by reference herein.

### BACKGROUND AND SUMMARY

The invention generally relates to recharging cartridges containing gas adsorbed into a solid contained in the cartridge, said cartridge being designed to equip a vehicle. Such cartridges were recently designed and currently constitute a promising means for storing a gas in view of its use in a vehicle. These cartridges make it possible to store a gas at storage pressures lower than those encountered in the case of pure gaseous storage. And a particularly advantageous application of this type of cartridge is the use of ammonia in applications for reducing nitrogen oxides NOx by selective catalytic reduction (SCR), particularly for reducing pollutant emissions for internal combustion engines, diesel engines in particular.

Such cartridges contain a gas (in the example mentioned above: ammonia) so as to make it available for use in association with the operation of the vehicle. The quantity of gas contained in the cartridge being limited, it is necessary to provide for replacement of the cartridge. Uses currently considered for these cartridges in nitrogen oxide (NOx) reduction applications by selective catalytic reduction (SCR), particularly for reducing pollutant emissions by internal combustion engines, consist of recovering the empty cartridges and transporting them (after having assembled them) to an industrial recharging site. After they are recharged with ammonia on the industrial site, the cartridges are again transported, toward a distribution center where vehicles can go to receive a new full cartridge.

Recharging on the industrial site is accomplished by supplying a batch of empty cartridges with a source of ammonia under pressure. In this recharging method, the cartridges are recharged in batches, and all the cartridges in the batch are put under a single pressure (which corresponds to the pressure of the source). The source of ammonia under pressure contains a considerably quantity of ammonia and makes it possible to establish a nominal pressure in the cartridges.

This scheme for replacing cartridges is practicable. It is, however, associated with certain constraints. One considerable constraint of this scheme arises from the fact that it requires the implementation of a relatively heavy logistical system for carrying recovered empty cartridges to the recharging center, and to then carry them from the recharging center to the distribution center. This logistical system requires in fact a particular infrastructure for transporting a gas, and this is true most particularly in the case of ammonia. This brings about complexity in operation and a cost.

Moreover, the logistics described above also generates delays in having a recharged cartridge available. It is of course possible to consider storing the ammonia outside the industrial recharging site, for example at recharging sites where users would come directly to have their cartridges recharged once their level is low. But this solution would involve providing expensive means for storing ammonia.

The invention proposes to alleviate these constraints and limitations. In order to achieve this objective, the invention proposes a device for recharging with ammonia a cartridge for reduction of nitrogen oxides by selective catalytic reduction, comprising:
Means for storing in memory characteristics of the cartridges to be recharged, said means comprising memory zones for at least one type of cartridge to be recharged,
   Said characteristics comprising, for each type of cartridge, recharging parameters of said type of cartridge,
Means for identifying the type of cartridge to recognize the type of a cartridge to be recharged,
Recharging means to provide for recharging the cartridge with a desired quantity of ammonia, said recharging means comprising:
   Means for receiving said recharging parameters coming from the memory means,
   A unit for manufacturing ammonia on demand, based on a manufacturing instruction,
   Means for controlling said manufacturing unit, to transmit to said manufacturing unit a manufacturing instruction corresponding to said desired quantity of ammonia,
Supply means for carrying out the recharging of the cartridge with said desired quantity of ammonia, said supply means comprising means for cooling the cartridge.

Advantageous, but non-limiting aspects of this device are the following:
The device also comprises
   In said memory means, a memory zone for storing, for each type of cartridge, a “purged nominal weight,” corresponding to a cartridge weight nominal value when said cartridge does not contain ammonia,
   Purging means for purging the cartridge to be recharged of its gaseous content,
   Weighing means for the cartridge to be recharged, to acquire a weight measured value of purged cartridge, called the “purged measured weight,”
   Means for measuring the variance between said purged measured weight and said purged nominal weight,
   Means for generating a purged weight alert if said variance exceeds a given threshold.
The device also comprises
   In said memory means, a memory zone for storing, for each type of cartridge, a “recharged nominal weight,” corresponding to a cartridge weight nominal value when said cartridge is filled with ammonia,
   Means for weighing the cartridge after it is recharged, to acquire a weight measured value of recharged cartridge, called the “recharged measured weight,”
   Means for measuring the variance between said recharged measured weight and said recharged nominal weight,
   Means for generating a recharged weight alert if said variance exceeds a given threshold.
The device also comprises means for triggering a self-diagnostic in the event of a recharged weight alert.
The self-diagnostic means comprise:
   Means for checking the quality of the ammonia manufactured by said manufacturing unit,
   Means for checking the temperature of the means for cooling the cartridge.

The invention also relates to a method for recharging with ammonia a cartridge for reduction of nitrogen oxides by selective catalytic reduction, comprising:
storing in memory characteristics of the cartridges to be recharged, for at least one type of cartridge to be recharged,
   Said characteristics comprising, for each type of cartridge, recharging parameters of said type of cartridge,
identifying the type of cartridge to recognize the type of a cartridge to be recharged,
recharging the cartridge with a desired quantity of ammonia, said recharging comprising:
   receiving of said recharging parameters,
   manufacturing ammonia on demand, based on a manufacturing instruction,
   controlling said manufacturing, with a manufacturing instruction corresponding to said desired quantity of ammonia,
supplying the cartridge with said desired quantity of ammonia.

The invention also relates to a method. Advantageously, prior to recharging the cartridge, this method also comprises the steps of:
storing in memory, for each type of cartridge, a “purged nominal weight,” corresponding to a cartridge weight nominal value when said cartridge does not contain ammonia,
purging the cartridge to be recharged of its gaseous content,
acquiring a weight measured value of purged cartridge, called the “purged measured weight,”
measuring the variance between said purged measured weight and said purged nominal weight,
generating a purged weight alert if said variance exceeds a given threshold.

### BRIEF DESCRIPTION OF THE DRAWING

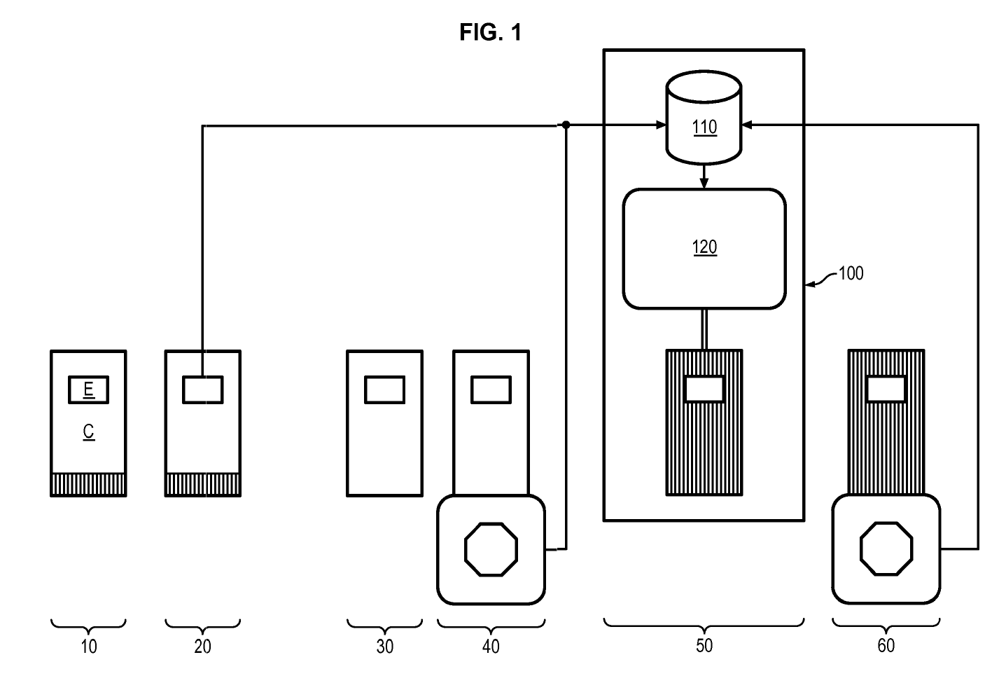

Other aspects, aims and advantages of the invention will be better revealed from reading the detailed description hereafter, made with reference to FIG. 1 which illustrates schematically the implementation of the invention on a cartridge. In this FIGURE, a same cartridge C is shown in successive states, during consecutive steps (some being optional) of the implementation of the invention.

### DETAILED DESCRIPTION

In the case of the invention, means and a particular method are provided to allow the recharging of empty cartridges, without being exposed to the limitations mentioned above. What is meant here by “cartridges” are cartridges containing ammonia adsorbed in a solid contained in the cartridge, said cartridge being designed to equip a vehicle. The solid can consist of a series of layers of salt and graphite. The selected salt has the property of adsorbing the ammonia and thus allowing it to be fixed, so as to free it during a desired utilization.

The use of this ammonia corresponds in the context of the invention to the reduction of nitrogen oxides NOx by selective catalytic reduction (SCR), particularly for reduction of pollutant emissions by internal combustion engines, in particular diesel engines. To this end, ammonia is freed to be mixed with the exhaust gases of the engine, thus allowing reduction in nitrogen oxides. This defines the context of the invention.

In the case of the invention, there is no provision for recharging cartridges in a central industrial unit, as is currently foreseen. Instead, the cartridges are recharged in a plurality of decentralized recharging stations. These stations can correspond for example to dealerships and automobile garages that customarily maintain vehicles. To allow recharging of cartridges in these places, without involving the installation of heavy equipment there, one of the aspects of the invention consists of not storing a reserve of ammonia. As such storage is subjected to heavy constraints, it is in fact advantageous to avoid it.

Instead of storing ammonia with the aim of recharging cartridges, the following procedure is followed. Empty cartridges are removed from the vehicle (typically by the dealer charged with maintaining the vehicle) into one of the recharging stations and placed in the device according to the invention. The empty condition of the cartridge is signaled by a measurement or a signal designed for this purpose.

In the recharging station, a device 100 according to the invention is provided. This device is capable of recharging the cartridge C (shown empty or quasi-empty in 10) without there being a need to store ammonia on site for the purpose of recharging cartridges. For this purpose, the device comprises memory means 110 for storing the characteristics of the cartridges to be recharged, said means comprising memory zones for at least one type of cartridge to be recharged. These memory means can comprise a memory, in which the characteristics of the cartridges (comprising in particular the recharging characteristics) are stored in association with the corresponding type of cartridge.

What is meant by “type of cartridge” is one of the predefined categories of cartridge, each category being defined by specifics such as the capacity of the cartridge. A set of categories of cartridges is thus defined a priori. These “cartridge characteristics” are typically different for each type of cartridge. They comprise, for each type of cartridge, recharging parameters of said type of cartridge. These recharging characteristics will be discussed further later. These characteristics can also comprise other information relating to the type of cartridge concerned.

The device also comprises means for identifying the type of cartridge presented by the user, to recognize the type of cartridge to be recharged. The cartridge, for its part, is provided with a label E, visible or not from the outside (it can for example be an RFID label). These means can for example comprise reading means in the form of a bar code reader or an RFID reader. This reading makes it possible to identify the type of cartridge, and this information on the type of cartridge is transmitted (step 20) to the memory means. Processing means associated with the memory means make it possible to consequently select the recharging characteristics of the cartridge.

In fact, the device makes it possible to recharge each cartridge according to its type. The device further comprises recharging means 120 to ensure the recharging of the cartridge with the desired quantity of ammonia. These recharging means, illustrated with reference to step 50, comprise:
Means for receiving said recharging parameters coming from the memory means. This is a connection (by wire or wireless) making it possible to retrieve in the memory means the recharging characteristics which are stored in association with the type of cartridge,
A unit for manufacturing ammonia on demand. This unit is designed to produce ammonia on demand (by electrolysis or by hydrolysis of urea, or by electrolysis of urine for example), according to a manufacturing instruction that it is able to receive,
Control means for said manufacturing unit, to transmit to said manufacturing unit a manufacturing instruction corresponding to the desired quantity of ammonia,
Supply means for carrying out recharging of the cartridge with said desired quantity of ammonia, said supply means comprising means for cooling the cartridge.

The manufacturing instruction is, in one embodiment, a manufacturing time for the ammonia, and for recharging the cartridge with the ammonia manufactured. In this embodiment, the ammonia is generated by the manufacturing unit with a defined pressure (this pressure is greater than atmospheric pressure, for example greater than 4 bars) during the recharging time, and it is the recharging time of the cartridge that determines the quantity of ammonia injected into the cartridge.

The options of the invention will be presented below. These options can be combined in all possible combinations.

### Option: Purging and Weighing of the Purged Cartridge

The option that will be presented in this section is elective for the device according to the invention, which can be created without purging and weighing means mentioned in this section. This option is important for the method according to the invention, as will be seen. It is also possible to provide that the memory means 110 of the device comprise a memory zone to store for each type of cartridge a “purged nominal weight,” in association with each type of cartridge. This purged nominal weight corresponds, for the type of cartridge concerned, to a nominal value of cartridge weight when said cartridge does not contain ammonia.

According to this option illustrated by steps 30 and 40 of the FIGURE, the device also comprises purging means for purging the cartridge to be recharged of its gaseous content. The cartridge thus appears empty in step 30. The purging means typically comprise a vacuum source (typically a pump calibrated to establish a low pressure, typically on the order of one or two centibars for example) and connection means from this vacuum source to the interior space of the cartridge.

This purge is intended to empty the cartridge of its possible gaseous content. This gaseous content can comprise residual ammonia. It can also comprise contaminants in gaseous form. It is advantageous, however, to ensure that such contaminants, which would be likely to degrade the performance (notably of storage) of the cartridge, are absent from the cartridge that will be recharged.

According to this option, the device also comprises means for weighting the cartridge to be recharged, to acquire (step 40) a weight measured value of purged cartridge, called the “purged measured weight.” This measurement is carried out after purging the cartridge.

And the device further comprises means for measuring the variance between said purged measured weight and said purged nominal weight, which is stored in memory. Finally, according to this option, the device comprises means for generating a purged weight alert if said variance exceeds a given threshold. This makes it possible to detect cartridges the weight whereof, after purging, is substantially different from the nominal—expected—weight of this type of cartridge when purged. Such a variance is in fact a symptom of a cartridge containing non-gaseous contaminants, the possible gaseous contaminants having been eliminated by purging. The non-gaseous contaminant can for example be water.

The device and the method according to this option of the invention thus make it possible to detect cartridges containing a non-gaseous contaminant. These cartridges can thus be set aside without recharging them, which avoids manufacturing ammonia for a defective cartridge.

Option: Weighing after Recharging—Advantage Inherent in this Option, Synergy with the Preceding Option, and Variant with Self-Diagnostic

According to another option illustrated by step 60, it is provided that the device also comprises in the memory means and in association with each type of cartridge, a memory zone for storing for the type of cartridge a “recharged nominal weight.” This recharged nominal weight corresponds to a nominal value—expected for a normal cartridge of this type—of cartridge weight when the cartridge is full of ammonia.

According to this option, the device also comprises means for weighing the cartridge after it is recharged, to acquire a weight measured value of recharged cartridge, called “recharged measured weight.” This weighing is carried out after recharging the cartridge. These weighing means can be the same as the weighing means mentioned in connection with the preceding option, if the two options are combined.

According to this option, the device comprises means for measuring the variance between said recharged measured weight and said recharged nominal weight. And the device also comprises means for generating a recharged weight alert if said variance exceeds a given threshold. In this manner cartridges are detected which, after recharging, have a weight substantially different from the weight expected for cartridges of the type identified.

This variance in the weight of the recharged cartridge can have one of the following causes:
the cartridge contains a gaseous or non-gaseous contaminant, (in the case where the preceding option has not been implemented—because if it was implemented, possible gaseous contaminants were removed by purging and possible non-gaseous contaminants have already been detected), or
the recharging method is defective, or
the storage material of the cartridge is defective (for example the layers of graphite contained in the compartments of the cartridge have flaws which alter their thermal conductivity properties).
   The measurement of this variance makes it possible to detect defective cartridges, and to avoid putting them back into circulation.

It should be noted that the combination of this option with the previously mentioned option is particularly advantageous. In fact, by combining these two options it is possible to:
thanks to the analysis of the measuring of the empty weight, prior to recharging, detect cartridges containing a non-gaseous contaminant, and
thanks to the analysis of the recharged weight, after recharging, detect cartridges whose storage material is defective, and signal exactly the cases wherein the recharging method is defective,
while simplifying the analysis of the recharged weight, because if the recharged weight has a variance with the recharged nominal weight, this variance is not due to the presence of contaminants in the cartridge (this cause would in fact have been detected during analysis of the first weighing, of the empty weight).

A variance detected between the recharged measured weight and the recharged nominal weight is thus likely to signal that the recharging method is defective, i.e., that the recharging means are not operating correctly. It is thus possible to provide supplementary means for automatically triggering a self-diagnostic of the device in the case of a recharged weight alert.

The self-diagnostic can in particular help in controlling:
the quality of the ammonia manufactured by said manufacturing unit. It is in this regard advantageous to check the water, hydrogen, CO₂ or nitrogen content of this ammonia,
the temperature of the cooling means of the cartridge. In fact, if these means are defective, the recharging of the cartridge with ammonia will not take place correctly.

The invention thus makes it possible to recharge cartridges without being exposed to the limitations mentioned in the introduction of this text with regard to the prior art. In addition the invention can be deployed in a particularly simple manner, because urea is now becoming easily available (for instance in service stations or in networks of automobile dealerships of certain vehicle brands). Thus one finds urea distribution points (particularly in the form of AdBlue (registered trademark of a solution of 32.5% urea diluted in water) covering a growing number of territories. And according to one variation, it is even possible to implement the invention by providing that the manufacturing unit produces ammonia from urine. In both cases, the “raw material” from which ammonia is manufactured is available on the spot, without requiring heavy storage constraints such as the constraints associated with the storage of ammonia.

1-7. (canceled)

8. A device for recharging with ammonia at least one cartridge for reduction of nitrogen oxides by selective catalytic reduction, comprising:
(a) memory zones adapted to store in memory characteristics of cartridges to be recharged, said memory zones being adapted for at least one type of said cartridge to be recharged,
said memory characteristics comprising, for each type of cartridge, recharging parameters of said type of said cartridge;
(b) an identification reader adapted to identify said type of said cartridge to recognize said type of said cartridge to be recharged;
(c) a recharger adapted to provide recharging of said cartridge with a desired quantity of said ammonia, said recharger comprising:
a receiver operably receiving said recharging parameters coming from said memory zones,
a unit operably manufacturing said ammonia on demand, based on a manufacturing instruction,
a controller operably controlling said manufacturing unit, to transmit to said manufacturing unit a manufacturing instruction corresponding to said desired quantity of said ammonia; and
(d) a supplier adapted to carry out said recharging of the cartridge with said desired quantity of said ammonia, said supplier comprising a cooler operably cooling said cartridge.

9. The device according to claim 8, wherein it also comprises:
in said memory zones, a memory zone for storing, for each type of cartridge, a “purged nominal weight,” corresponding to a cartridge weight nominal value when said cartridge does not contain said ammonia;
a vacuum operably purging said cartridge to be recharged of its gaseous content;
weighing said cartridge to be recharged, to acquire a weight measured value of said purged cartridge, called a “purged measured weight;” measuring a variance between said purged measured weight and said purged nominal weight; and
generating a purged weight alert if said variance exceeds a given threshold.

10. The device according to claim 8, wherein that it also comprises:
in said memory zones, for each type of cartridge, a “recharged nominal weight,” corresponding to a cartridge weight nominal value when said cartridge is filled with said ammonia;
weighing the cartridge after it is recharged, to acquire a weight measured value of recharged cartridge, called a “recharged measured weight;”
measuring a variance between said recharged measured weight and said recharged nominal weight; and
generating a recharged weight alert if said variance exceeds a given threshold.

11. The device according to claim 10, wherein it also comprises a self-diagnostic unit operably triggering a self-diagnostic of said device in a case of a recharged weight alert.

12. The device according to claim 11, wherein the self-diagnostic unit:
checks said quality of said ammonia manufactured by said manufacturing unit; and
checks said temperature of said cooler for cooling said cartridge.

13. A method for recharging with ammonia at least one cartridge for reduction of nitrogen oxides by selective catalytic reduction, the method comprising:
(a) storing in memory characteristics of said cartridges to be recharged, for at least one type of said cartridge to be recharged;
said characteristics comprising, for each type of said cartridge, recharging parameters of said type of said cartridge;
(b) identifying said type of said cartridge to recognize said type of said cartridge to be recharged;
(c) recharging said cartridge with a desired quantity of said ammonia, said recharging comprising:
receiving said recharging parameters,
manufacturing said ammonia on demand, based on a manufacturing instruction,
controlling said manufacturing, with a manufacturing instruction corresponding to said desired quantity of said ammonia; and
(d) supplying said cartridge with said desired quantity of said ammonia.

14. The method according to claim 13, wherein, prior to recharging said cartridge, said method also comprises:
storing in said memory, for each type of said cartridge, a “purged nominal weight,” corresponding to a cartridge weight nominal value when said cartridge does not contain said ammonia;
purging said cartridge to be recharged of its gaseous content;
acquiring a weight measured value of said purged cartridge, called the “purged measured weight;”
measuring a variance between said purged measured weight and said purged nominal weight; and
generating a purged weight alert if said variance exceeds a given threshold.
